(19) United States
(12) Patent Application Publication
(10) Pub. No.: US 2019/0066321 A1
(43) Pub. Date: Feb. 28, 2019

(54) METHOD AND IMAGE-PROCESSING DEVICE FOR DETERMINING A GEOMETRIC MEASUREMENT QUANITTY OF AN OBJECT

(71) Applicant: Testo SE & Co. KGaA, Lenzkirch (DE)

(72) Inventors: Jan-Friso Evers-Senne, Titisee-Neustadt (DE); Hellen Alterndorf, Kirchzarten (DE)

(73) Assignee: Testo SE & Co. KGaA, Lenzkirch (DE)

(21) Appl. No.: 16/075,786

(22) PCT Filed: Feb. 13, 2017
(86) PCT No.: PCT/EP2017/000197

§ 371 Date: Aug. 6, 2018

(30) Foreign Application Priority Data
Feb. 24, 2016 (DE) 10 2016 002 186.1

(51) Int. Cl. G06T 7/60; G06T 5/00; G06T 7/579

(52) U.S. Cl. CPC G06T 7/60; G06T 2207/10028; G06T 7/579; G06T 5/006

(57) ABSTRACT

The invention relates to a method and to an image recording device (1) for determining a geometric measurement quantity (3) of an object (2), wherein at least one visual image (4) of the object (2) is recorded in a recording step, a true-to-scale 3-D image of the object (2) is recorded and/or calculated in a 3-D image creation step, a subset of 3-D points of the 3-D image is calculated in a point cloud calculation step, a geometric primitive is fit to the subset of 3-D points using a computer in a fitting step, a feature selection is applied to the at least one visual image in a feature detection step in order to identify at least two feature points (9, 10) in the visual image (4), the at least two feature points (9, 10) are projected onto the geometric primitive as at least two measurement points (12, 13) in a projection step (11), and a geometric measurement quantity (3) is calculated for the at least two measurement points (12, 13) in a calculation step.

### BACKGROUND

The invention relates, firstly, to a method and, secondly, to an image recording apparatus for determining a geometric measured variable of an object. By way of example, such a geometric measured variable can be a spatial distance and/or an area.

Such methods for determining a geometric measured variable are known per se and always based on at least one manual processing step and, secondly, on scaling the image by an additionally required scale. In order to be able to use a recorded image for determining a geometric measured variable, manual preparation steps for image processing are required, for example for a distortion correction and/or for perspective distortion correction, which need a user to be trained.

### SUMMARY

Therefore, there is the object of developing an improved method by way of automation, in which the aforementioned disadvantages have been overcome, for the purposes of simplifying the determination of a geometric measured variable.

This object is achieved by a method with one or more features according to the invention. In particular, a method for determining a geometric measured variable of an object is proposed according to the invention for achieving the object, wherein:
at least one visual image of the object is recorded in a recording step,
a 3D image of the object, true to scale, is recorded and/or calculated in a 3D image creation step,
a subset of 3D points of the 3D image is calculated in a point cloud calculation step,
a geometric primitive is fit using a computer for the subset of 3D points in a fitting step,
a feature selection is applied to the at least one visual image in a feature detection step in order to identify at least two feature points in the visual image,
the at least two feature points are projected onto the geometric primitive as at least two measurement points in a projection step,
a geometric measured variable is calculated for the at least two measurement points in a calculation step.

In this way, the invention allows, on the one hand, fisheye images and/or a distortion and/or a perspective distortion of the recorded visual image for determining a geometric measured variable to be correctable and, on the other hand, the measurement accuracy to be increased in relation to a direct use of a 3D model. In particular, it can be particularly advantageous that no manually carried out intermediate step, for example for determining a geometric measured variable, is necessary. As an exception to this, it may be expedient for the feature selection to be undertaken manually by the user. By fitting a geometric primitive into a subset of 3D points, it is moreover possible to reduce measurement inaccuracies, for example as a result of a noisy recording of the 3D image. Thus, the geometric primitive corresponds to an approximation of the actual geometric form or surface of the object. Provision can be made for the geometric measured variable to be a spatial distance, in particular a width, a height, a distance, in particular the shortest and/or greatest distance, between two boundary lines, and/or a diagonal, and/or an area, in particular of the entire object or of a part thereof. The totality of all 3D points that are recorded by a 3D camera also can be referred to as 3D image or point cloud. Consequently, the invention is advantageous in that the aforementioned manual preparation steps of the image processing prior to determining the geometric measured variable are dispensable since they can be carried out, and are carried out, in an automated fashion.

Different geometric primitives, in particular for different surfaces of the object, can be calculated depending on the geometric form of the object. By way of example, provision can be made according to the invention for a preferably parameterized and/or edged cone lateral part, cylinder lateral part and/or plane part to be used in the fitting step of the method according to the invention as geometric primitive. By way of example, if a plane surface or a part thereof, such as a building wall, should be surveyed by the method according to the invention, as described and claimed herein, a spatial direction can be determined (in particular as a normal direction or by a normal direction and/or as a direction of extent of the plane object) for the object, embodied as a building wall, by fitting a geometric primitive, embodied as a plane part, into the subset of 3D points.

Further, it may be expedient in a specific configuration of the method according to the invention if a grouping step is carried out prior to carrying out the fitting step in order to determine, preferably using a computer, a spatial direction for each 3D point and subsequently assign the 3D points, preferably using a computer, to a subset of 3D points according to their respective spatial directions. In particular, provision according to the invention can be made here for a local plane to be initially calculated and, from this, a normal vector to be calculated, in each case using a computer, for each 3D point.

In order to create a 3D image in the 3D image creation step of the method according to the invention, it can be advantageous if use is made of an image recording apparatus with a 3D camera for recording the 3D image. By way of example, a time-of-flight sensor for carrying out a time-of-flight measurement of an optical signal, a laser scanner and/or a stereo camera can be suitable 3D cameras. Moreover, it may likewise be expedient to calculate, in particular calculate using a computer, the 3D image in the 3D image creation step by way of a multi-image construction method from a sequence of a plurality of visual images. By way of example, the sequence of a plurality of visual images can be recorded by a visual camera, wherein, preferably, the individual visual images are recorded from different camera poses. By way of example, the structure-from-motion method can be a suitable method in this case.

As an alternative or in addition thereto, provision can be made according to the invention in the 3D image creation step for a mark to be imaged on the object, in particular to be projected onto the object and/or to be applied to the object, and/or for a distance measurement to be carried out between an image recording apparatus, or the already aforementioned image recording apparatus, and the object. The mark can have, for example, a pattern, preferably made of a plurality of pattern constituents, with scaling and/or determining of the spatial direction of the object being possible with the aid of the mark imaged onto the object. Moreover, the distance measurement can supply a further parameter that can be used for calculating the scaling of the object.

Therefore, it may be expedient if a mark, preferably a mechanical mark, is imaged with the object, for example by way of an arrangement at or near the object, in particular wherein the dimensions of the mark are known. As a result, the scale of the object and/or a determination of the spatial direction of the object can be determined easily. As an alternative or in addition thereto, it may be expedient according to a further advantageous configuration of the invention if the mark is projected onto the object as a laser cross. By way of example, the spatial direction of the object can be determined more accurately by way of the degree of the distortion of the laser cross from a camera pose in the recorded image. Here, a projector, by which the laser cross is projected or projectable, is rigidly coupled to the image recording apparatus. Consequently, a scale of the recorded object can be established from a known optical axis spacing (baseline) using known methods. Moreover, provision can also be made according to the invention, in an alternative or complementary manner, for a multi-beam distance measurement to be carried out, in particular with the individual measurements each being directed to different measurement points on the object. An improved determination of the spatial direction of the object is possible by the multi-beam distance measurement. Preferably, the visual image and/or the 3D image is/are projected and recorded from a stationary position, in particular a coupled position.

In one configuration of the method according to the invention, it may be expedient if the visual image and the 3D image are each recorded from a stationary camera pose, in particular from a coupled camera pose. In this configuration, it is sufficient for a visual image and a 3D image to be recorded in each case. Moreover, it is particularly advantageous that the simplest possible projection of feature points onto the geometric primitive as measurement points is possible.

A substantial disadvantage of known methods is based on the fact that a certain amount of experience is necessary for selecting at least two feature points in a manual intermediate step. By way of example, it may be necessary, in the process, for the user to require a high click accuracy when selecting the feature points. According to a configuration of the method according to the invention, it may be expedient if the selection of at least two feature points in the feature detection step is undertaken by an automated feature detection using a computer. When recording the object, the user merely has to take care not to lie outside of the object. However, an accuracy that is as high as in the case of the manual selection in already known methods is not necessary. Consequently, for as long as the user ensures by way of a check of the content that they remain within the identified object or the plane thereof and do not select projecting or recessed details in relation thereto, the placement of feature points for the measurement according to the invention is rendered simpler. As an alternative or in addition thereto, it may likewise be conceivable according to the invention for the selection of at least two feature points to be undertaken by manual feature selection.

As an alternative or in addition thereto, provision can be made in the method according to the invention for, in a plausibility check, the fit of the geometric primitive to be checked and/or optimized using a computer. In particular, this can be undertaken in such a way that outliers of 3D points within a subset of 3D points are removed when fitting the geometric primitive, said outliers, in particular, being caused by measurement errors. Carrying out a plausibility check is therefore advantageous in that the spatial direction of the geometric primitive is calculable in a particularly accurate manner.

It may further be particularly advantageous if, in the method according to the invention, a RANSAC method and/or a region growing method is applied in the fitting step. These methods each facilitate particularly good fitting of the geometric primitive into the subset of 3D points.

According to a further configuration form of the method according to the invention, provision can be made for the object to have a plane and/or a rectangular area, for which a geometric measured variable is determined. By way of example, a spatial distance and/or an area can be a geometric measured variable.

According to further configuration of the method according to the invention, it may be expedient if a time-of-flight measurement and/or a structure-from-motion method is used for calculating the 3D image. By way of example, the time-of-flight method can be a suitable time-of-flight measurement.

In a further configuration of the method according to the invention, provision can be made, alternatively or additionally, for a distortion correction and/or a correction of a local aberration of the visual image or of the visual images and/or of the 3D image to be undertaken in an automated manner and/or using a computer. The distortion correction and/or a correction of a local aberration should ideally take place before creating a 3D image from a plurality of visual images in the visual images used to this end. As an alternative or in addition thereto, provision, according to the invention, can be made for the distortion correction and/or a correction of a local aberration to be undertaken before the fitting step. Consequently, a distortion correction step can increase the accuracy when determining a geometric measured variable. Furthermore, the computer-assisted and/or automated distortion correction and/or correction of a local aberration may facilitate a quick calculation of the geometric measured variable.

The aforementioned object is also achieved by an image recording apparatus with one or more features of the invention. In particular the invention thus proposes an image recording apparatus for determining a geometric measured variable of an object, having:
a visual camera for recording at least one visual image and a 3D camera for recording a 3D image or a visual camera for recording a sequence of a plurality of visual images and a 3D image creation unit for calculating a 3D image from the sequence of a plurality of visual images,
a point cloud calculation unit for calculating a subset of 3D points of the 3D image,
a fitting unit for fitting a geometric primitive into the subset of 3D points,
a feature detection unit for manual selection and/or for automatic selection of at least two feature points in the at least one visual image,
a projection unit for projecting the at least two feature points onto the geometric primitive as at least two measurement points,
a calculation unit for calculating the geometric measured variable for the at least two measurement points.

In relation to previously known image recording apparatuses, the image recording apparatus according to the invention is advantageous, for example, in that therewith the calculation of a geometric measured variable of an object, in particular without a manual intermediate step which, for example, has to be carried out by a further input device, such as a PC. By use of the image recording apparatus according to the invention, the user can undertake a measurement directly in situ and can also obtain a result directly in situ. Preferably, all functional units of the image recording apparatus according to the invention are programmable in such a way that these can operate in an automated fashion. However, in a certain configuration, it may be expedient if the feature selection can be carried out, at least optionally, in a manual fashion by the user.

According to a preferred configuration of the image recording apparatus according to the invention, it can be expedient if the point cloud calculation unit is configured to determine a spatial direction of a 3D point, preferably calculate the latter automatically using a computer. Determining the spatial direction of a 3D point can be advantageous in that the 3D points are assignable using a computer according to the spatial directions of subsets of 3D points. Therefore, the point cloud calculation unit can be configured so as to be able to assign the 3D points according to their spatial directions to subsets of 3D points. In particular, the point cloud calculation unit can be configured to initially render determinable a local plane for each 3D point using a computer and subsequently allow a normal vector to be calculated therefrom using a computer. Therefore, an assignment to subsets of the 3D points can be carried out according to their normal vectors, for example.

In an alternative or complementary manner, provision can be made in a further preferred configuration of the image recording apparatus according to the invention for the image recording apparatus to have a plausibility checking device for checking and/or optimizing the geometric primitive. By way of example, it may be expedient if the plausibility checking device is configured to undertake an optimization of the geometric primitive until a minimized discrepancy is present between the 3D points and the actual points of the geometric primitive. The actual points of the geometric primitive relate to those points which lie directly on the geometric primitive. Therefore, the plausibility checking device renders it possible to obtain an increased accuracy when calculating the geometric measured variable.

It may be particularly expedient if provision is made in the image recording apparatus according to the invention for the visual camera for recording at least one visual image and the 3D camera to be coupled to one another. In particular, coupling can be configured by virtue of the two cameras being connected or connectable to one another by way of a connection element, preferably with a defined and/or adjustable distance. As a result of this configuration according to the invention of an image recording apparatus, it may be possible to facilitate a geometric measured variable of an object already by recording only a single visual image and only a single 3D image.

According to a further configuration of the image recording apparatus according to the invention, provision can alternatively or additionally be made for this image recording apparatus to have a grouping unit. The grouping unit can be configured to carry out an implementation of a grouping step using a computer, in particular wherein a spatial direction is determinable for each 3D point and the 3D points are assignable to a subset of 3D points using a computer according to their spatial direction. In particular, provision can be made for the point cloud calculation unit and the grouping unit to be embodied as a single unit. It may be particularly expedient if initially a local plane and, therefrom, a normal vector is calculable with computer assistance for each 3D point.

The image recording apparatus according to the invention, as described and claimed herein, can preferably be configured to be able to carry out the method according to the invention, as described and claimed herein. It is for this reason that the same advantages as the advantages that were already described above for the method according to the invention arise for the configuration of such an image recording apparatus according to the invention.

According to a particularly advantageous embodiment of the image recording apparatus according to the invention, provision can be made for the image recording apparatus to have a correction unit for carrying out, in particular for carrying out in an automated and/or computer assisted manner, a distortion correction and/or a correction of a local aberration of the visual image or of the visual images and/or of the 3D image. In particular, this correction unit can be configured in such a way that a correction step to be carried out, for example before producing a 3D image from a sequence of visual images, is implemented in all visual images from the sequence and/or in such a way that a correction step to be carried out is implemented prior to the projection of the at least two feature points onto the geometric primitive as at least two measurement points.

### BRIEF DESCRIPTION OF THE DRAWINGS

Now, the invention will be described in more detail on the basis of a use example, although it is not restricted to this use example. Further use examples according to the invention emerge by combining individual features and/or a plurality of features of the claims among themselves and/or with individual features or a plurality of features of the use example.

In the figures:

FIG. 1 shows a simplified schematic illustration of a visual image, in which an object is imaged in a certain perspective,

FIG. 2 shows a simplified schematic illustration in a plan view of an embodiment of the image recording apparatus according to the invention, said image recording apparatus being used to survey an object,

FIG. 3 shows two subsets of 3D points of a 3D image of the object, which are imaged once as filled points and once as unfilled points, wherein a geometric primitive is fitted into a subset of 3D points (filled 3D points),

FIG. 4 shows a projection of two feature points, which are selected in the visual image, onto the geometric primitive according to FIG. 3 for the purposes of calculating the geometric measured variable, the corresponding measurement points projected onto the geometric primitive,

FIG. 5 shows a visual image with a strongly distorted image with a measurement error resulting therefrom between the edges of the imaged object,

FIG. 6 shows a visual image of the object corrected by a distortion correction.

### DETAILED DESCRIPTION

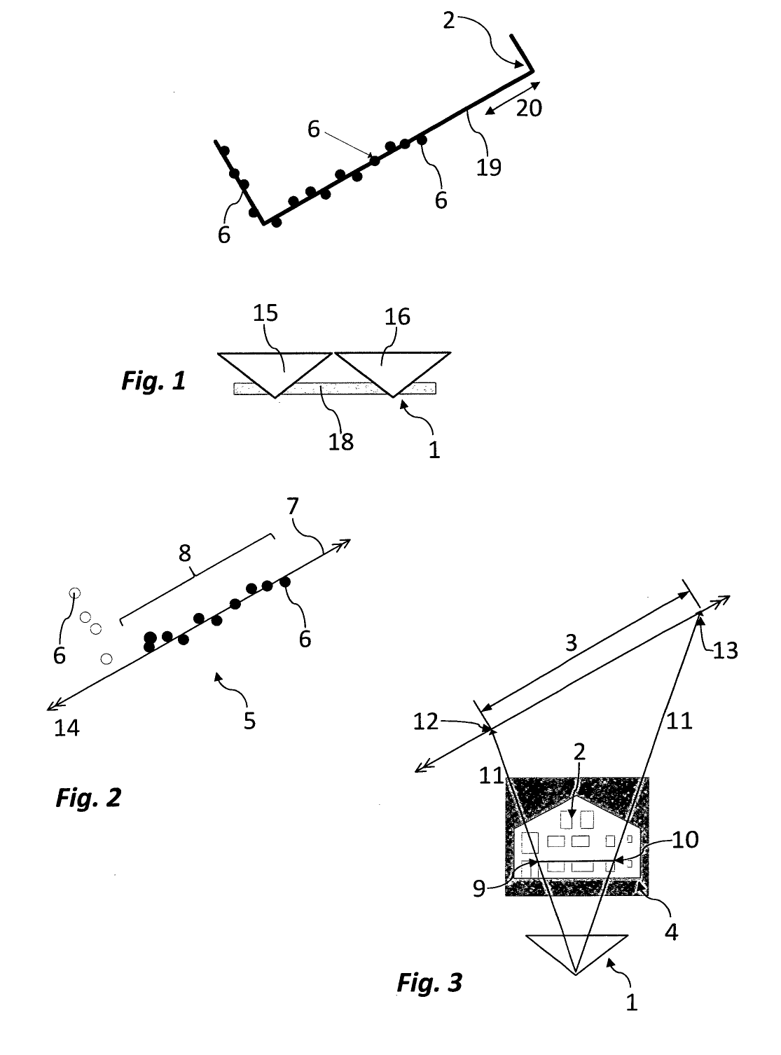

FIG. 1 shows an image recording apparatus 1 according to the invention and FIGS. 2 and 3 illustrate steps of a method according to the invention in a simplified schematic manner, as may be carried out by the image recording apparatus 1 according to the invention, for example.

The image recording apparatus 1 is configured to determine a geometric measured variable 3 of an object 2. The image recording apparatus 1 has a visual camera 16 and a 3D camera 15 according to the present embodiment according to the invention. The two cameras 15, 16 are coupled to one another at a preferably defined and/or adjustable distance by way of a connection element 18. This configuration according to the invention is advantageous in that there is no need for distance measurement for determining the geometric measured variable 3.

However, alternatively, it may also be conceivable for the image recording apparatus 1 according to the invention to only have a visual camera 16 for recording a sequence of a plurality of visual images 4, and a 3D image creation unit for calculating a 3D image 5 from the sequence of a plurality of visual images 4 (not illustrated). Moreover, provision can be made here for an image recording apparatus 1 configured in this way to have a distance measuring unit. Moreover, the image recording apparatus 1 according to the invention can have a projector for projecting a mark, in particular a visual mark, onto the object 2, in particular onto an object plane 19.

Further, the image recording apparatus 1 according to the invention has a point cloud calculation unit for calculating a subset 8 of 3D points 6 of the 3D image 5. For the purposes of fitting a geometric primitive 7, which, like in the present case, may be configured as a plane part, for example, into the subset 8 of 3D points 6, the image recording apparatus 1 according to the invention has a fitting unit. Moreover, the image recording apparatus 1 has a feature detection unit, which may be configured, for example, to be able to undertake by manual selection of at least two feature points 9, 10 in the visual image. As an alternative or in addition thereto, provision can likewise be made for the feature detection unit to be configured, in particular programmable, to allow an automatic selection of at least two feature points 9, 10 in the visual image 4 to be undertaken. In order to be able to take account of a certain spatial direction 20 of the object 2 when calculating the geometric measured variable 3, the image recording apparatus 1 according to the invention has a projector for projecting 11 the at least two selected feature points 9, 10 onto the geometric primitive 7 as at least two measurement points 12, 13. By projecting 11 the feature points 9, 10 as measurement points 12, 13 onto the geometric primitive 7, it is possible to determine the geometric measured variable 3 for the at least two measurement points 12, 13. The spatial direction 14, in particular the direction of extent, of the geometric primitive 7 in this case corresponds approximately or completely to the actual spatial direction 20, in particular the direction of extent, of the object 2.

As can be seen in FIG. 1, the 3D points 6 of the 3D image 5 may have inaccuracies, which is why these do not lie exactly in a plane, in particular in a plane corresponding to the object plane 19, but instead are positioned in a partly deviating manner outside of the plane. By fitting a geometric primitive 7, as shown in FIG. 2, it is possible to place a compensation plane through the subset 8 of 3D points 6 in order to be able to determine the spatial direction 20 of the object 2. When subdividing the 3D points 6 into subsets 8, the respective spatial direction of each 3D point 6 is initially calculated and taken into account, in order to finally undertake a subdivision.

Subsequently, as shown in FIG. 3, by selecting at least one first feature point 9 and a second feature point 10 in the visual image 4, which is displayable by the image recording apparatus 1, for example by a display, it is possible to carry out a manual and/or automatic selection.

By projecting 11 the feature points 9, 10 onto the geometric primitive 7, corresponding measurement points 12, 13 can be calculated, preferably using a computer, for the at least two feature points 9, 10.

Subsequently, a calculation of the geometric measured variable 3, such as, for example, a spatial distance between the two feature points 9, 10 of the object 2 here, can be undertaken by the calculation unit of the image recording apparatus 1 according to the invention.

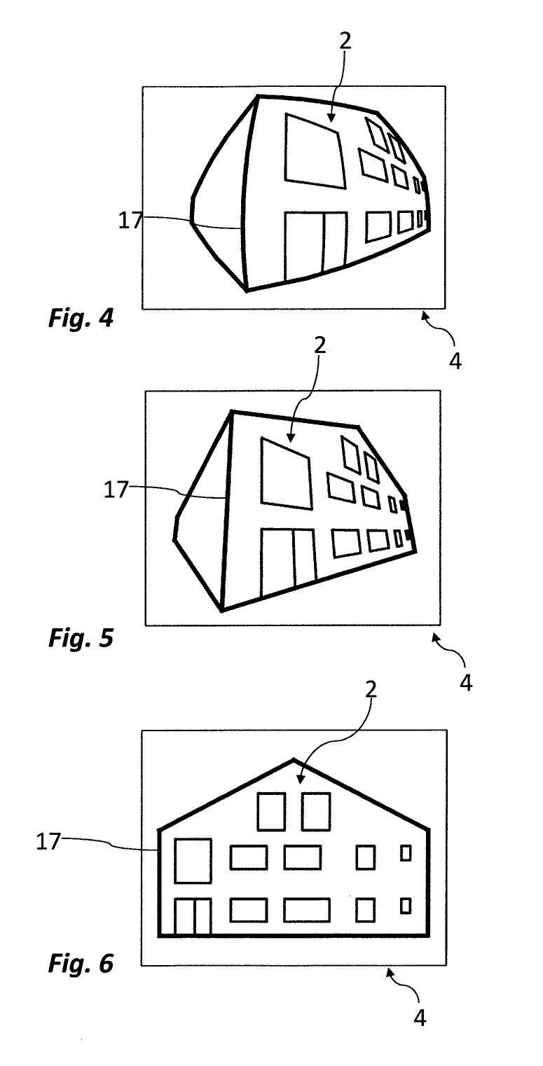

The image recording apparatus 1 according to the invention further has a distortion correction unit, by which it is possible to undertake a correction of a local imaging aberration of the visual image 4 and/or of the 3D image 5, preferably in an automated fashion and/or using a computer. FIGS. 4 to 6 show, in a schematic embodiment, the sequence of processing a visual image 4 that was recorded by the visual camera 16. A visual image 4 and/or a 3D image can image the edges of the object 17 as being not straight, despite these edges 17 in actual fact extending in a straight line, for example due to distortion errors and/or due to recording the image by a fisheye camera. In the case illustrated in FIG. 4, the visual image 4 of the object 2 has a barrel-shaped distortion. As illustrated in FIG. 5, a distortion correction can be undertaken, in particular in an automated fashion and using a computer, by the distortion correction unit of the image recording apparatus 1 according to the invention such that a distortion-free visual image 4 arises (see the corrected visual image 4 in FIG. 5). FIG. 6 shows an orthogonal illustration of the visual image 4 (as a plan view and/or ortho-image or ortho-photo), which is creatable by the image recording apparatus 1 according to the invention, in particular from the distortion-free visual image 4.

Further, the image recording apparatus 1 according to the invention is configured to carry out the method according to the invention, as described and claimed herein, wherein, preferably, all method steps are implementable using a computer, preferably in an automatic manner, with the exception of the feature detection step which is selectively implementable in an automated and/or manual manner. Thus, in the method according to the invention, as described and claimed herein, the position and the orientation of an image recording apparatus relative to the object 2 is known or establishable.

Thus, in the method according to the invention, as described and claimed herein, or in the use of the image recording apparatus 1 according to the invention, as described and claimed herein, it is not necessary to carry out a plurality of setting up steps manually, for example by photograph measurement software. In particular, manual steps, by which a lens distortion must be corrected, a perspective image must be set up and/or scaling must be set up, are dispensed with in the process. All these steps can be undertaken in an automated manner by the image recording apparatus 1 according to the invention and/or by the method according to the invention. As a result, setting up steps that are complicated and susceptible to errors are dispensed with for the user. Rather, said user can survey an object, in particular the geometry of an object, directly in situ.

In order to be able to undertake an automated feature selection using a computer, in particular by the feature detection unit, it may be expedient if this is carried out by way of a feature extraction. It may be a further advantage if a geometric primitive 7 is already possible by capturing a number of at least three 3D points 6 in order to be able to determine the spatial direction 20, in particular the direction of extent, of the object 2. As a rule, the more 3D points 6 of a subset 8 are taken into account during the fitting, the higher the accuracy of the spatial direction 14 of the geometric primitive 7 in relation to the spatial direction 20 of the object 2, wherein outliers can be excluded.

### LIST OF REFERENCE SIGNS

1 Image recording apparatus
2 Object
3 Geometric measured variable
4 Visual image
5 3D image
6 3D point
7 Geometric primitive
8 Subset of 3D points
9 First feature point
10 Second feature point
11 Projection of the feature points
12 First measurement point
13 Second measurement point
14 Spatial direction of the geometric primitive
15 3D camera
16 Visual camera
17 Edge of the object
18 Connection element
19 Object plane
20 Spatial direction of the object

1. A method for determining a geometric measured variable (3) of an object (2), the method comprising:
recording at least one visual image (4) of the object (2) in a recording step,
at least one of recording or calculating a 3D image (5) of the object (2), true to scale, using a computer in a 3D image creation step,
calculating a subset (8) of 3D points (6) of the 3D image (5) with the computer in a point cloud calculation step,
fitting a geometric primitive (7) with the computer for the subset (8) of 3D points (6) in a fitting step,
applying a feature selection to the at least one visual image (4) in a feature detection step in order to identify at least two feature points (9, 10) in the visual image (4),
projecting the at least two feature points (9, 10) with the computer onto the geometric primitive (7) as at least two measurement points (12, 13) in a projection step, and
calculating a geometric measured variable (3) with the computer for the at least two measurement points (12, 13) in a calculation step.

2. The method as claimed in claim 1, wherein at least one of a parameterized or edged cone lateral part, a cylinder lateral part, or a plane part is used in the fitting step as the geometric primitive (7).

3. The method as claimed in claim 1, wherein the 3D image (5) is recorded by an image recording apparatus (1) with a 3D camera (15) in the 3D image creation step or the 3D image (5) is calculated by way of a multi-image reconstruction from a sequence of a plurality of the visual images (4) which were recorded by an image recording apparatus (1) with a visual camera (16).

4. The method as claimed in claim 1, wherein the visual image (4) and the 3D image (5) are each recorded from a stationary camera pose.

5. The method as claimed in claim 1, wherein the selection of at least two feature points (12, 13) in the feature detection step is undertaken by at least one of an automated feature detection with the computer or a manual feature selection.

6. The method as claimed in claim 1, further comprising: applying at least one of a RANSAC method or a region growing method in the fitting step.

7. The method as claimed in claim 1, further comprising:
using at least one of a time-of-flight measurement or a structure-from-motion method for calculating the 3D image (5).

8. An image recording apparatus (1) for determining a geometric measured variable (3) of an object (2), the image recording apparatus comprising:
a visual camera (16) adapted to record at least one visual image (4) and a 3D camera (15) adapted to record a 3D image (5) or a visual camera (16) adapted to record a sequence of a plurality of visual images (4) and a 3D image creation unit configured to calculate calculating a 3D image (5) from the sequence of a plurality of visual images (4),
a computer configured with a point cloud calculation unit to calculate a subset (8) of 3D points (6) of the 3D image (5),
the computer configured with a fitting unit that fits a geometric primitive (7) into the subset (8) of 3D points (6),
the computer configured with a feature detection unit for at least one of manual selection or automatic selection of at least two feature points (9, 10) in the visual image (4),
the computer configured with a projection unit for projecting the at least two feature points (9, 10) onto the geometric primitive (7) as at least two measurement points (12, 13), and
the computer configured with a calculation unit that calculates the geometric measured variable (3) for the at least two measurement points (12, 13).

9. The image recording apparatus (1) as claimed in claim 8, wherein the point cloud calculation unit is configured to determine a spatial direction of the 3D point (6), in order to assign the 3D points (6) according to spatial directions thereof to the subsets (8) of 3D points (6).

10. The image recording apparatus (1) as claimed in claim 8, wherein the visual camera (16) for recording at least one visual image (4) and the 3D camera (15) are coupled to one another such that they are connected to one another by a connection element (18).

11. (canceled)

12. The image recording apparatus (1) as claimed in claim 8, further comprising a correction unit configured to carry out at least one of an automated or computer assisted distortion correction or correction of a local aberration of at least one of the visual image (4) the visual images (4), or the 3D image (5).

13. The method of claim 1, further comprising:
determining a spatial direction with the computer for each of the 3D points (6) in a grouping step prior to carrying out the fitting step, the 3D points (6) being assigned with the computer to the subset (8) according to spatial directions thereof.

14. The method of claim 13, wherein a local plane is initially calculated and, from this, a normal vector is calculated, in each case with the computer, for each of the 3D points (6).

15. The method of claim 3, further comprising:
imaging a mark on the object (2) in the 3D image creation step or carrying out a distance measurement between the image recording apparatus (1) and the object (2).

16. The method of claim 1, wherein in a plausibility check, a fit of the geometric primitive (7) is at least one of checked or optimized with the computer, such that outliers within a subset (8) of 3D points (6) are removed when fitting the geometric primitive (7), said outliers being caused by measurement errors.

17. The method of claim 1, wherein the object (2) has a plane area for which the geometric measured variable (3) is determined.

18. The method of claim 3, further comprising:
carrying out a distortion correction step, a distortion correction or a correction of a local aberration of the visual image (4), the visual images (4), or the 3D image (5) with the computer.

19. The image recording apparatus (1) as claimed in claim 8, further comprising a plausibility checking device configured to at least one of check or optimize the geometric primitive (7), said plausibility checking device being configured to undertake an optimization of the geometric primitive (7) until there is a minimized discrepancy between the 3D points (6) and actual points of the geometric primitive.

20. The image recording apparatus (1) as claimed in claim 8, further comprising a grouping unit configured to carrying out a grouping step, wherein a spatial direction is determined for each of the 3D points (6) and the 3D points are assigned to a subset (8) with the computer according to the spatial directions thereof, such that for each 3D point (6), initially a local plane and, therefrom, a normal vector are calculated.

21. The image recording apparatus (1) as claimed in claim 12, wherein the correction is carried out at least one of before creating a 3D image (5) in the case of all visual images (4) from the sequence of the plurality of visual images (4) or before projecting the at least two feature points (9, 16) onto the geometric primitive (7) as at least two measurement points (12, 13).
